(19) United States
(12) Patent Application Publication
(10) Pub. No.: US 2010/0097584 A1
(43) Pub. Date: Apr. 22, 2010

(54) EXPOSURE APPARATUS AND DEVICE FABRICATION METHOD

(75) Inventor: Kentaro Doguchi, Utsunomiya-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/444,103

(22) PCT Filed: Dec. 5, 2007
(86) PCT No.: PCT/JP2007/073905

§ 371 Date: Apr. 2, 2009

(30) Foreign Application Priority Data
Dec. 13, 2006 (JP) 2006-336005

(51) Int. Cl. G03B 27/52

(52) U.S. Cl. 355/30

(57) ABSTRACT

An exposure apparatus which exposes a substrate via a liquid supplied between a projection optical system and the substrate, the apparatus comprises a gas supply-recovery mechanism configured to blow a gas around the liquid, wherein the gas supply-recovery mechanism includes a nozzle unit in which a supply port configured to supply the gas, and a recovery port which is arranged nearer to an optical axis of the projection optical system than the supply port and is configured to recover the gas are formed, and wherein the nozzle unit is configured such that a first portion which is adjacent to the supply port and is nearer to the optical axis than the supply port is closer to an image plane of the projection optical system than a second portion which is adjacent to the supply port and is farther from the optical axis than the supply port.

### TECHNICAL FIELD

The present invention relates to an exposure apparatus which exposes a substrate via a liquid, and a device fabrication method using the exposure apparatus.

### BACKGROUND ART

A projection exposure apparatus which causes a projection optical system to project and transfer a circuit pattern formed on a reticle onto a wafer has conventionally been used. In recent years, a demand for an exposure apparatus which simultaneously attains high resolution and high throughput is increasing. As a technique for meeting the demand for high resolution, immersion exposure is receiving a great deal of attention. The immersion exposure further increases the numerical aperture (NA) of the projection optical system by using a liquid as a medium that fills the space between the projection optical system and the wafer. Letting n be the refractive index of the medium, the NA of the projection optical system is n·sin θ. From this relationship, the NA can be increased to n times that of air (n≈1) by filling that space with a medium having a refractive index (n>1) higher than that of the air. This makes it possible to improve a resolution R (R=k₁ (λ/NA) where k₁ is the process constant, and λ is the wavelength of a light source) of the exposure apparatus.

There is proposed immersion exposure using a local fill method which locally fills the space between the projection optical system and the wafer with a liquid (International Publication WO99/49504 and WO2004/086470 brochures). There is also proposed an air curtain method which blows a gas around the liquid supplied between the projection optical system and the wafer to form an air curtain, thereby confining the liquid between the projection optical system and the wafer (Japanese Patent Laid-Open No. 2004-289126 and International Publication WO2004/093159 brochure).

Unfortunately, when the wafer is driven at a speed as high as 400 mm/s or more, the methods disclosed in Japanese Patent Laid-Open No. 2004-289126 and International Publication WO2004/093159 brochure can hardly obtain a gas flow rate sufficient to form an air curtain which can block the liquid splashing from the space between the projection optical system and the wafer. For this reason, the filling liquid scatters to the periphery. As the scattered droplets vaporize, they can act as impurities on the wafer and eventually produce pattern defects on the wafer. Still worse, as the filling liquid runs short upon scattering, bubbles can mix in it. The bubbles mixed in the liquid diffuse exposure light to reduce the exposure amount, resulting in a decrease in throughput.

### DISCLOSURE OF INVENTION

The present invention has been made in consideration of the above-described situation, and provides a novel technique for suppressing a liquid supplied to the space between a projection optical system and a substrate from scattering to the periphery.

According to one aspect of the present invention, there is provided an exposure apparatus which exposes a substrate via a liquid, the apparatus comprising a projection optical system configured to project a pattern image of an original onto the substrate, a liquid supply-recovery mechanism configured to supply the liquid between the projection optical system and the substrate, and to recover the liquid, and a gas supply-recovery mechanism configured to blow a gas around the liquid supplied between the projection optical system and the substrate, wherein the gas supply-recovery mechanism includes a nozzle unit in which a supply port configured to supply the gas, and a recovery port which is arranged nearer to an optical axis of the projection optical system than the supply port and is configured to recover the gas are formed, and wherein the nozzle unit is configured such that a first portion which is adjacent to the supply port and is nearer to the optical axis than the supply port is closer to an image plane of the projection optical system than a second portion which is adjacent to the supply port and is farther from the optical axis than the supply port.

According to another aspect of the present invention, there is provided an exposure apparatus which exposes a substrate via a liquid, the apparatus comprising a projection optical system configured to project a pattern image of an original onto the substrate, a liquid supply-recovery mechanism configured to supply the liquid between the projection optical system and the substrate, and to recover the liquid, and a gas supply-recovery mechanism configured to blow a gas around the liquid supplied between the projection optical system and the substrate by using a coanda effect.

According to still another aspect of the present invention, there is provided a device fabrication method comprising steps of exposing a substrate using the above exposure apparatus, performing a development process for the substrate exposed.

Further objects and aspects of the present invention will become apparent from the following description of exemplary embodiments with reference to the attached drawings.

### BRIEF DESCRIPTION OF DRAWINGS

FIG. 1 is a schematic block diagram showing the arrangement of an exposure apparatus.

FIG. 2 is an enlarged sectional view showing the periphery of nozzle units of an exposure apparatus according to the first embodiment.

FIG. 3 is an enlarged sectional view showing the nozzle unit of the exposure apparatus according to the first embodiment.

FIG. 4 is an enlarged sectional view showing the periphery of nozzle units of an exposure apparatus according to a modification to the first embodiment.

FIG. 5 is an enlarged sectional view showing the periphery of nozzle units of an exposure apparatus according to the second embodiment.

FIG. 6 is an enlarged sectional view showing the nozzle unit of the exposure apparatus according to the second embodiment.

FIG. 7A is a diagram showing a simulated flow rate distribution around the nozzle unit.

FIG. 7B is a diagram showing another simulated flow rate distribution around the nozzle unit.

FIG. 8 is a graph showing the experimental result of gas recovery effect examination.

FIG. 9 is a flowchart for explaining a method for fabricating devices.

FIG. 10 is a detail flowchart of a wafer process in Step 4 of FIG. 9.

FIG. 11A is a schematic sectional view of a second supply port taken along a plane parallel to the image plane of a projection optical system.

FIG. 11B is a schematic sectional view of another second supply port taken along the plane parallel to the image plane of the projection optical system.

FIG. 12A is a schematic sectional view of a second recovery port taken along a plane parallel to the image plane of the projection optical system.

FIG. 12B is a schematic sectional view of another second recovery port taken along the plane parallel to the image plane of the projection optical system.

FIG. 13 is an enlarged sectional view showing the periphery of nozzle units of an exposure apparatus according to a modification to the first embodiment.

### BEST MODE FOR CARRYING OUT THE INVENTION

Embodiments of an exposure apparatus 1 according to one aspect of the present invention will be described below with reference to the accompanying drawings.

### First Embodiment

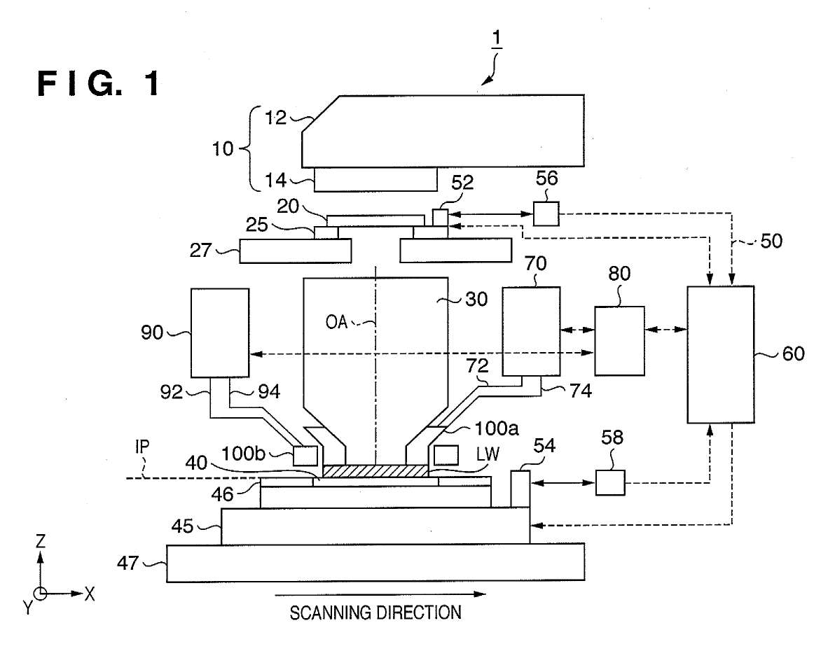

FIG. 1 is a schematic block diagram showing the arrangement of an exposure apparatus 1 according to one aspect of the present invention. The exposure apparatus 1 includes a projection optical system 30 which projects light from a reticle (mask) 20 to form an image. The exposure apparatus 1 is an immersion exposure apparatus which exposes a wafer (also called a substrate) 40 via the reticle 20, the projection optical system 30, and a liquid LW supplied between the wafer 40 and a final optical element (final lens) of the projection optical system 30 on the side of the wafer 40. Although the exposure apparatus 1 adopts the step-and-scan manner in the first embodiment, it can adopt the step-and-repeat manner.

The exposure apparatus 1 includes an illumination apparatus 10, a reticle stage 25, the projection optical system 30, a wafer stage 45, a distance measurement apparatus 50, a stage control unit 60, a liquid supply-recovery mechanism 70, an immersion control unit 80, a gas supply-recovery mechanism 90, and nozzle units 100a and 100b.

The illumination apparatus 10 illuminates the reticle 20 on which a pattern (circuit pattern) to be transferred is formed, and includes a light source unit 12 and illumination optical system 14.

In the first embodiment, the light source unit 12 uses an ArF excimer laser with a wavelength of about 193 nm as a light source. However, the light source of the light source unit 12 is not particularly limited to the ArF excimer laser, and may use, for example, a KrF excimer laser with a wavelength of about 248 nm or an F₂ laser with a wavelength of about 157 nm.

The illumination optical system 14 illuminates the reticle 20, and includes, for example, a lens, mirror, optical integrator, and aperture stop.

The reticle 20 is supported and driven by the reticle stage 25. The reticle 20 is an original on which a circuit pattern to be transferred is formed. The pattern image of the reticle 20 is projected onto the wafer 40 via the projection optical system 30. The reticle 20 is optically conjugate to the wafer 40. Since the exposure apparatus 1 is of the step-and-scan manner, it scans the reticle 20 and wafer 40 at a speed ratio matching the reduction magnification ratio to transfer the pattern of the reticle 20 onto the wafer 40.

The reticle stage 25 is supported by a stool 27. The reticle stage 25 mounts (holds) the reticle 20. A moving mechanism (not shown) and the stage control unit 60 control the movement of the reticle stage 25. The moving mechanism (not shown) includes, for example, a linear motor, and drives the reticle stage 25 in the scanning direction (the X-axis direction in the first embodiment) so as to move the reticle 20.

The projection optical system 30 projects the pattern of the reticle 20 onto the wafer 40. The projection optical system 30 can use a dioptric or catadioptric system.

The wafer 40 is supported and driven by the wafer stage 45. The wafer 40 is an example of a photosensitive substrate which broadly includes a glass plate and others. The wafer 40 is coated with a photoresist.

The wafer stage 45 is supported by a stool 47 and mounts (holds) the wafer 40. When the Z-axis is parallel to the optical axis of the projection optical system, and the X- and Y-axes are perpendicular to the Z-axis and orthogonal to each other, the wafer stage 45 can be translated along the respective axes and can rotate about the respective axes. The stage control unit 60 controls these motions.

The wafer stage 45 is provided with an auxiliary plate 46. The surfaces of the wafer 40 and auxiliary plate 46 mounted on the wafer stage 45 are practically flush with each other. The auxiliary plate 46 allows forming a liquid film in the outer region of the wafer 40 (i.e., support the liquid LW) in edge shot immersion exposure.

The distance measurement apparatus 50 measures the two-dimensional positions of the reticle stage 25 and wafer stage 45 in real time using reference mirrors 52 and 54 and laser interferometers 56 and 58. The distance measurement apparatus 50 transmits the distance measurement results to the stage control unit 60.

The stage control unit 60 controls to drive the reticle stage 25 and wafer stage 45. Based on the distance measurement results obtained by the distance measurement apparatus 50, the stage control unit 60 drives the reticle stage 25 and wafer stage 45 at a constant speed ratio to perform alignment and synchronous control. In addition, the stage control unit 60 controls the wafer stage 45 such that the surface of the wafer 40 accurately matches the focal plane (an image plane IP) of the projection optical system 30.

The liquid supply-recovery mechanism 70 supplies the liquid LW between the projection optical system 30 and the wafer 40 via a liquid supply pipe 72, and recovers, via a liquid recovery pipe 74, the liquid LW supplied between the projection optical system 30 and the wafer 40. The liquid LW is selected from liquids with low absorbances of exposure light, and preferably has a refractive index nearly equal to that of a dioptric element made of, for example, quartz or fluorite. The liquid LW uses, for example, pure water, functional water, or a fluorinated liquid (e.g., fluorocarbon).

Preferably, dissolved gasses are sufficiently removed from the liquid LW in advance using a deaerator (not shown). This is to suppress the generation of bubbles and to immediately absorb them, if any, in the liquid. For example, when nitrogen and oxygen gasses contained in the ambient air in large quantities are removed from the liquid LW by 80% or more of their dissolution limits, it is possible to sufficiently suppress the generation of bubbles. It is also possible to build a deaerator (not shown) in the liquid supply-recovery mechanism 70 to supply the liquid LW while always removing the dissolved gasses. A preferable example of the deaerator is a vacuum deaerator which uses a gas permeable film and supplies the liquid LW to its one side and evacuate its other side, thereby forcing the dissolved gasses in the liquid into a vacuum via this film. The liquid supply-recovery mechanism 70 generally includes, for example, a tank for storing the liquid LW, a purifier for purifying the liquid LW, a pressure feed unit for feeding the liquid LW, a controller for controlling the flow rate and temperature of the liquid LW, and a suction device which draws the liquid LW by suction.

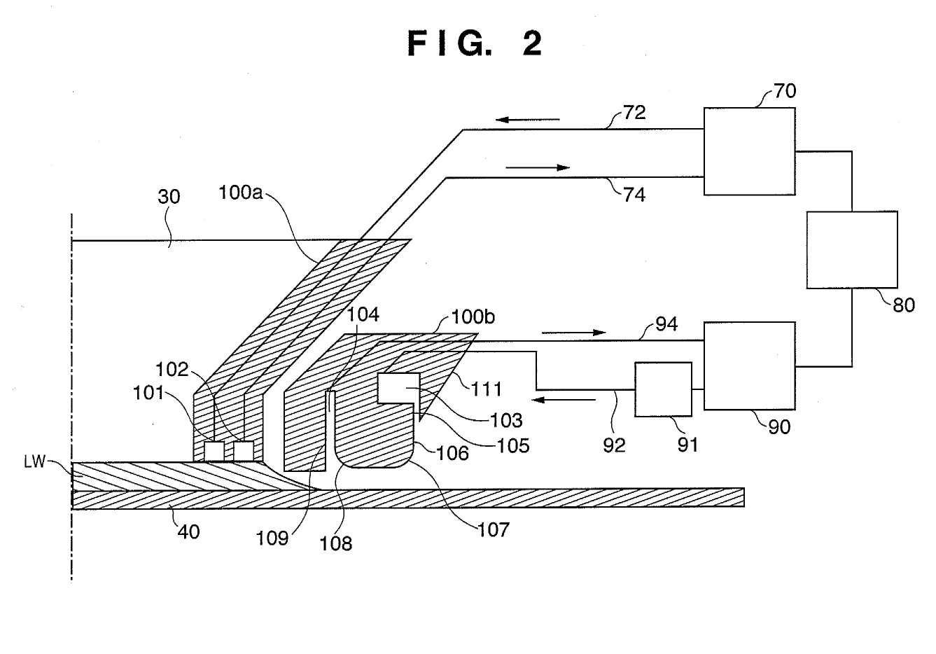

As shown in FIG. 2, the liquid supply pipe 72 is arranged around the final optical element of the projection optical system 30, which faces the wafer 40. The liquid supply pipe 72 connects to a liquid supply port 101 formed in the nozzle unit 100a. With this arrangement, the liquid supply pipe 72 supplies the liquid LW between the projection optical system 30 and the wafer 40 to form a liquid film of the liquid LW. The projection optical system 30 and the wafer 40 preferably have an interval of, for example, 1.0 mm so as to stably form a liquid film of the liquid LW. FIG. 2 is a sectional view taken along a plane including an optical axis OA of the final optical element of the projection optical system 30. The final optical element uses a planoconvex lens in which a surface matching the plane comes into contact with the liquid LW.

The liquid supply pipe 72 is preferably made of, for example, a Teflon® resin, polyethylene resign, or polypropylene resin, each of which elutes less so as not to contaminate the liquid LW. If the liquid LW uses a liquid other than pure water, the liquid supply pipe 72 is made of a material which has a resistance to the liquid LW and elutes less.

The liquid recovery pipe 74 is arranged around the liquid supply pipe 72 and connects to a liquid recovery port 102 formed in the nozzle unit 100a. Similar to the liquid supply pipe 72, the liquid recovery pipe 74 is preferably made of a material which has a resistance to the liquid LW and elutes less so as not to contaminate the liquid LW.

The immersion control unit 80 acquires information on, for example, the current position, speed, acceleration, target position, and moving direction of the wafer stage 45 from the stage control unit 60, and controls the liquid supply-recovery mechanism 70 based on this information. More specifically, the immersion control unit 80 controls the switching between the supply and recovery of the liquid LW, the stop of the liquid LW, and the supply amount and recovery amount (flow rate) of the liquid LW.

The gas supply-recovery mechanism (air curtain forming unit) 90 supplies (blows), via a gas supply pipe 92, a gas PG around the liquid LW supplied between the projection optical system 30 and the wafer 40, and recovers the supplied gas PG via an gas recovery pipe 94. In other words, the gas supply-recovery mechanism 90 supplies (blows) the gas PG around the liquid LW to form an air curtain (a gas curtain) for suppressing the liquid LW from scattering to the periphery. The air curtain also suppresses the liquid LW from coming into contact with the external environment.

The gas supply pipe 92 is made of various resins and a metal such as stainless steel, and connects to a space 103 formed in the nozzle unit 100b, as shown in FIG. 2.

Similar to the gas supply pipe 92, the gas recovery pipe 94 is made of various resins and a metal such as stainless steel, and connects to a second recovery port 104 formed in the nozzle unit 100b. The gas recovery pipe 94 recovers the gas (a gas stream AG2) via the second recovery port 104.

A gas conditioner 91 serves to control the temperature and the humidity (the concentration of the vapor of the liquid LW, which is contained in the gas PG) of the gas PG. The gas PG from the gas conditioner 91 is supplied to a second supply port 105 via the gas supply pipe 92. The gas PG uses, for example, an inert gas such as nitrogen, helium, neon, or argon gas or air such as clean dry air. The gas conditioner 91 includes a humidity (concentration) measurement unit (not shown) and a temperature measurement unit (not shown). The humidity (concentration) measurement unit measures the humidity (concentration) of the gas PG. The temperature measurement unit measures the temperature of the gas PG.

As shown in FIG. 2, the nozzle unit 100b includes a slit-like second supply port 105 which blows out a gas, guide wall surfaces 106 and 107 which guide the gas PG from the second supply port 105, and a wall surface 111 which forms an outer wall.

The guide wall surface 106 forms a straight line in a plane (in the sheet surface) including the optical axis OA. The guide wall surface 107 includes a line which comes close to the wafer 40 as it comes close to the optical axis OA in the plane including the optical axis OA. The wall surface 111 includes a line which separates from the wafer 40 as it separates from the optical axis OA in the plane including the optical axis OA.

A first portion of the nozzle unit 100b, which includes the guide wall surfaces 106 and 107, is closer to the wafer 40 than a second portion of the nozzle unit 100b, which includes the wall surface 111.

The nozzle unit 100b includes the second recovery port 104, a guide wall surface 108 for guiding the gas PG to the second recovery port 104, and a guide wall surface 109 facing the guide wall surface 108. The guide wall surface 108 included in a third portion of the nozzle unit 100b includes a line which separates from the wafer 40 as it comes close to the optical axis OA in the plane including the optical axis OA. Although the guide wall surface 109 is perpendicular to the wafer 40 in the first embodiment, it may be an oblique surface with respect to the wafer 40 or may be a recessed surface.

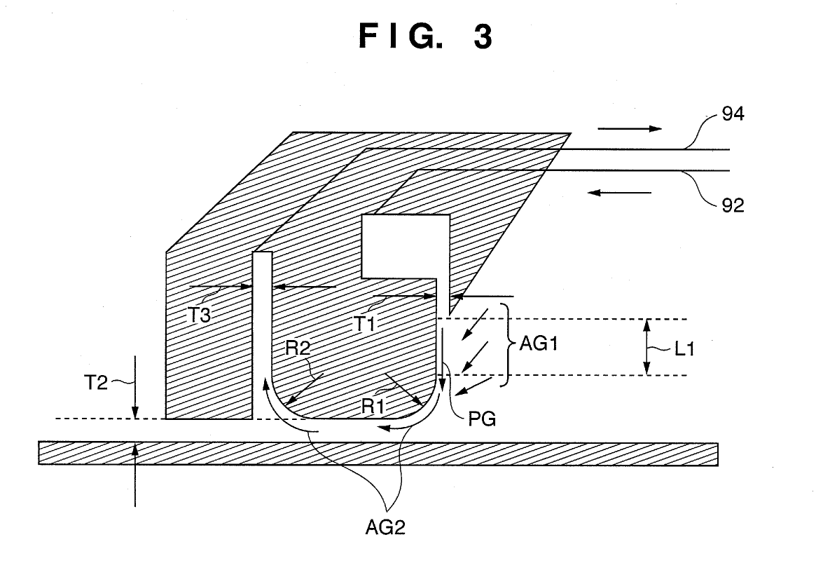

FIG. 3 is an enlarged sectional view of the nozzle unit 100b shown in FIG. 2, which is taken along the plane including the optical axis OA of the projection optical system, similar to FIG. 2.

The operation and effect of the nozzle unit 100b according to the first embodiment will be explained with reference to FIGS. 2 and 3. The gas PG supplied from the gas supply pipe 92 is blown out from the second supply port 105 toward the wafer 40 at high speed, and flows along the guide wall surfaces 106 and 107. Since the fast gas stream blown out from the second supply port 105 produces a negative pressure, it traps an ambient gas AG1 in large quantities by the Bernoulli effect to form an amplified gas stream AG2. The amplified gas stream AG2 is guided between the wafer 40 and the nozzle unit 100b along the guide wall surface 107 by the coanda effect. The gas stream AG2 is bent to separate from the wafer 40 along the guide wall surface 108 by the coanda effect again, and is recovered via the second recovery port 104. This structure can produce the following three effects.

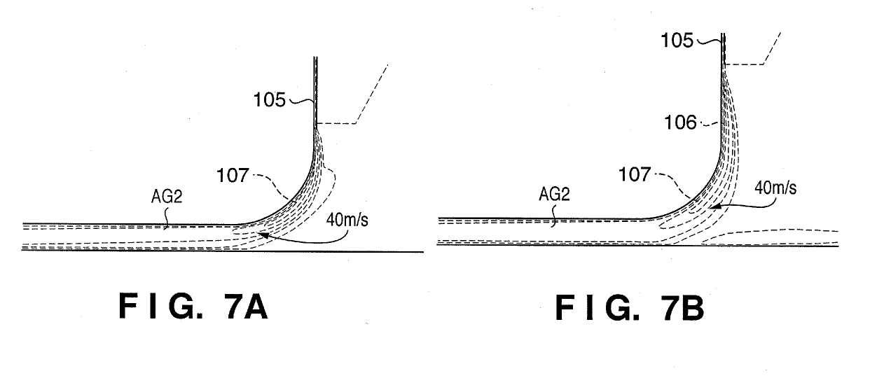

First, it is possible to amplify the gas flow rate by guiding the gas PG from the second supply port 105 along the guide wall surface 106 and trapping the ambient gas AG1. The conventionally known air curtain nozzles do not have such an amplification function and therefore can hardly obtain a gas flow rate sufficient to confine the liquid LW. In contrast, the structure according to the present invention can obtain a gas stream AG2 at a flow rate amplified from the supply flow rate. Even when the wafer 40 moves at high speed during exposure, the liquid LW can be suppressed from scattering to the periphery. To efficiently guide the gas PG to the space between the wafer 40 and the nozzle unit 100b, a length L1 of the guide wall surface 106 is desirably shorter than ten times a slit width T1 of the second supply port 105. This is because when the gas PG blown out from the second supply port 105 travels by a distance ten times the slit width T1 or more, it decelerates before reaching the guide wall surface 107. FIGS. 7A and 7B show simulated flow rate distributions when L1=0 [mm] and L1=30×T1 [mm], respectively. The interval between constant speed lines is 10 m/s.

Second, it is possible to efficiently guide the gas between the wafer 40 and the nozzle unit 100b using the guide wall surface 107. The conventional air curtain nozzles blow a gas from a direction perpendicular to the wafer or an oblique direction with respect to the wafer. However, this method wastes several tens of % of introduced gas that flows in a direction opposite to the liquid LW. In contrast, the structure according to the present invention can efficiently guide the supplied and amplified gas stream AG2 between the wafer 40 and the nozzle unit 100b. Referring to FIG. 3, let T1 be the width of the second supply port 105, and R1 be the radius of curvature of the guide wall surface 107 having an arc to which the guide wall surface 106 and the lower surface of the nozzle unit 100b are tangent. Then, to obtain the effects of the first embodiment, T1 and R1 are preferably set to satisfy T1/R1<0.35. Although both the guide wall surface 106 and the lower surface of the nozzle unit 100b are tangent to the arc, it is also possible to form an arc to which at least one of the guide wall surface 106 and the lower surface of the nozzle unit 100b is tangent.

Third, it is possible to stabilize the side surface (the interface with the gas) of the liquid LW while the wafer is at rest or moving slowly by guiding and recovering the gas stream AG2 using the curved guide wall surface 108 inside (closer to the optical axis OA) the second supply port 105. When the amplified gas stream AG2 directly comes into contact with the side surface of the liquid LW while wafer is at rest or moving slowly, the gas-liquid interface becomes unstable and bubbles can mix in the liquid LW. However, the conventional method of using only a suction force from the gas recovery port to bend the path of a gas stream traveling along the surface of the wafer 40 can hardly recover most of it. To solve this problem, the first embodiment achieves efficient recovery by bending the gas stream AG2 along the guide wall surface 108 using the coanda effect. Referring to FIG. 3, let T2 be the minimum value of the distance between the surface (the image plane IP of the projection optical system 30) of the wafer 40 and the lower surface of the nozzle unit 100b, and R2 be the radius of curvature of the guide wall surface 108. Then, to obtain the above-described effect, the relationship between T2 and R2 preferably satisfies:

T2/R2<0.60

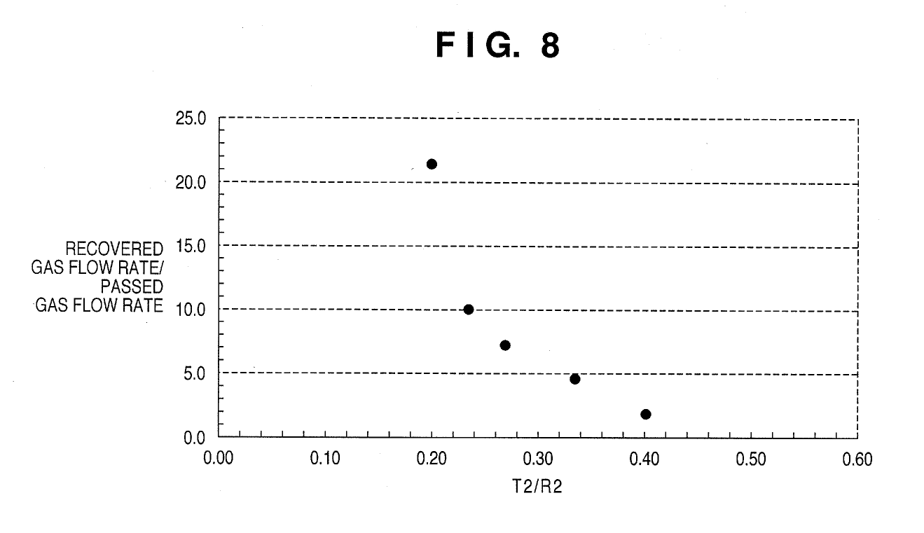

FIG. 8 is a graph showing the experimental result of gas recovery effect examination. The ordinate indicates the ratio of the flow rate of a gas which could be recovered to that which could not be recovered and passed through, and the abscissa indicates T2/R2. This graph reveals that, when the above-described condition is satisfied, the recovered gas flow rate is higher than the passed gas flow rate (the flow rate of the gas which could not be recovered). An embodiment of the nozzle units 100a and 100b shown in FIGS. 2 and 3 will be explained below.

A nozzle unit 100a which concentrically surrounds a projection optical system 30 comprises a liquid supply port 101 for supplying a liquid and a liquid recovery port 102 for recovering the liquid. Similarly, a nozzle unit 100b which concentrically surrounds the projection optical system 30 and is arranged outside the nozzle unit 100a comprises a second supply port 105 for supplying a gas and a second recovery port 104 for recovering the gas.

Referring to FIGS. 2 and 3, the dimensions of the nozzle unit 100b were set in the following manner to satisfy the above-described condition. A width T1 of the second supply port 105 was set at 0.1 mm, and a length L1 of a guide wall surface 106 was set at 0 mm. Both radii R1 and R2 of curvatures of the guide wall surfaces 107 and 108 were set at 3.0 mm. An interval T2 between a wafer 40 and the nozzle unit 100b was set at 1.0 mm, and a width T3 of the second recovery port 104 was set at 2.0 mm. The angle of a wall surface 111 which forms the outer wall of the nozzle unit 100b with respect to an optical axis OA was set at 30°.

A procedure for exposing the wafer 40 will be explained here. If neither a wafer 40 nor auxiliary plate 46 is present under the projection optical system 30, the space under the projection optical system 30 is filled with a gas. While the wafer 40 or auxiliary plate 46 is present under the projection optical system 30, the liquid supply port 101 starts supplying a liquid LW (for example, pure water). At the same time, the liquid recovery port 102 starts recovering the liquid to hold the liquid LW in a region surrounded by the projection optical system 30, liquid recovery port 102, and wafer 40. The liquid LW can use various kinds of materials such as the one having a refractive index higher than that of pure water, that is, an organic or inorganic substance.

At the time of exposure, the second supply port 105 supplies a gas PG such as air, and simultaneously, the second recovery port 104 inside it recovers the gas (a gas stream AG2). When the liquid LW uses an organic or inorganic substance other than pure water, the supplied gas PG preferably uses the vapor of the same material as the liquid LW or an inert gas which contains the vapor of the liquid LW as a vapor composition and has a low partial pressure of oxygen. The inert gas preferably uses, e.g., nitrogen or helium gas. Using an inert gas having a low partial pressure of oxygen makes it possible to suppress the liquid LW from coming into contact with the oxygen gas which decreases the transmittance of exposure light. Since the temperature of the gas PG decreases due to adiabatic expansion upon blowing it from the second supply port 105, the temperature of the wafer 40 is preferably controlled by supplying a gas PG at a temperature slightly higher than the target temperature of the wafer 40.

In the prior arts, when the wafer 40 moves at a speed as high as, for example, 600 mm/s during, for example, exposure, the liquid LW is dragged by the surface of the wafer 40 and therefore leaks out from under the nozzle unit 100a. In contrast, according to this embodiment, as described previously, the leaked liquid LW is stopped under the nozzle unit 100b by the gas AG2 in an amount amplified from the supply amount, and hence never leaks out beyond it.

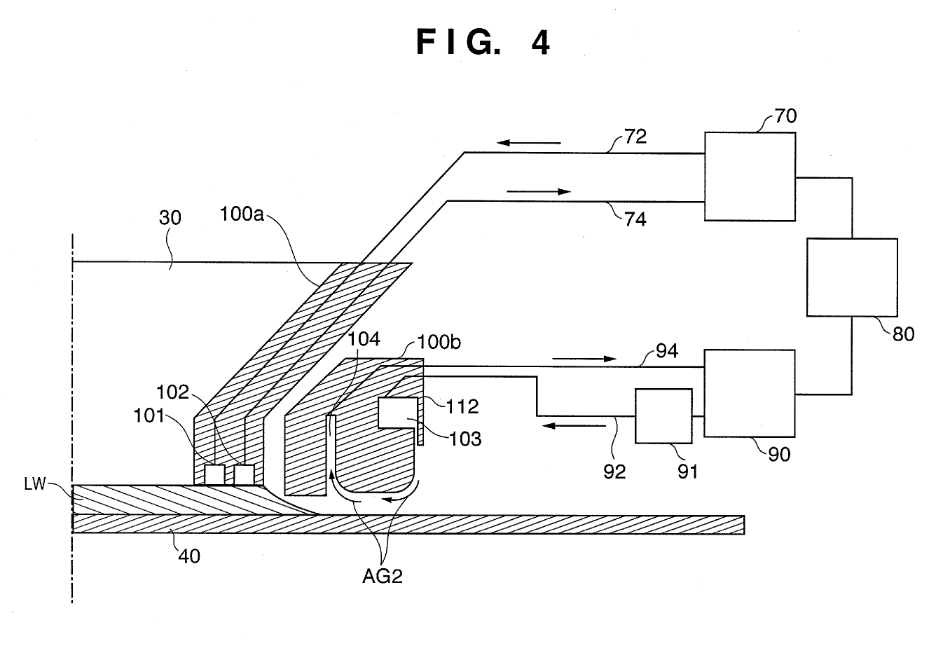

Although the second supply port 105 and second recovery port 104 concentrically surround the projection optical system 30 in this embodiment, the shapes of the second supply port 105 and second recovery port 104 are not limited to a circle and may be a polygon and the like. In addition, although the wall surface 111 is formed obliquely with respect to the optical axis OA, a wall surface 112 parallel to the optical axis OA as shown in FIG. 4 may be formed.

### Second Embodiment

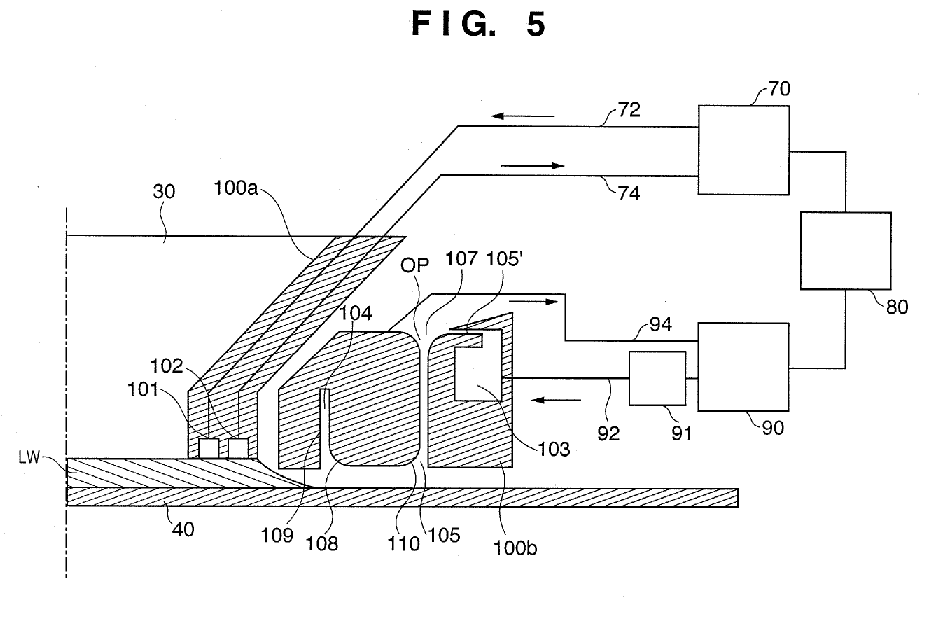

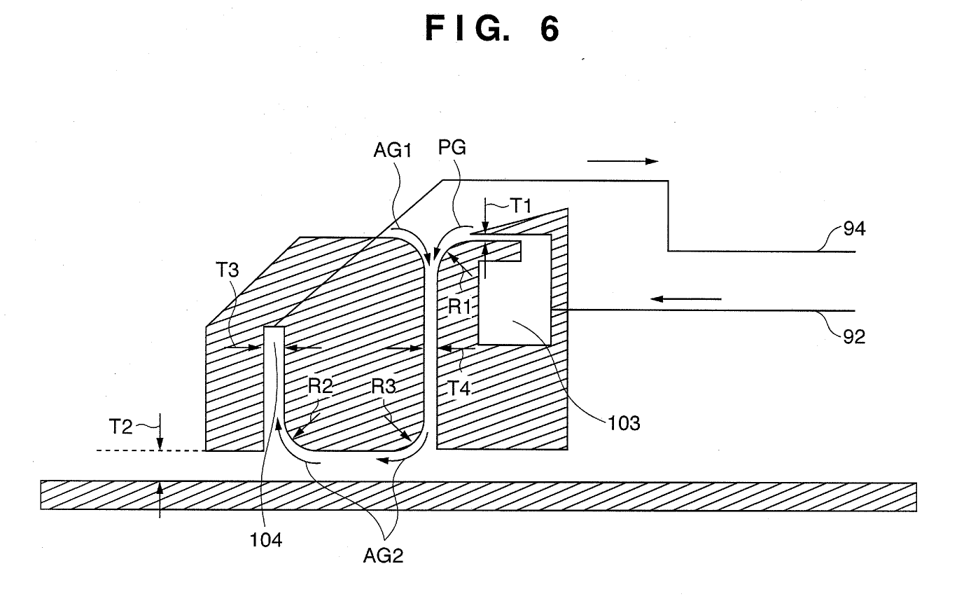

Another embodiment of the present invention will be described below with reference to FIGS. 5 and 6. FIGS. 5 and 6 are sectional views taken along a plane including an optical axis OA. The second supply port 105 serving as a blowing port of the gas PG faces down in the first embodiment, whereas a slit 105′ serving as a blowing port of a gas PG faces sideways in the second embodiment.

A nozzle unit 100a which concentrically surrounds a projection optical system 30 includes a liquid supply port 101 for supplying a liquid, and a liquid recovery port 102 for recovering the liquid. Similarly, a nozzle unit 100b which concentrically surrounds the projection optical system 30 and is arranged outside the nozzle unit 100a includes the slit 105′ for supplying a gas, an opening OP, and a second recovery port 104. The gas PG supplied from the slit 105′ is bent toward a wafer 40 along a guide wall surface (curved surface) 107 by the coanda effect. The gas PG traps an ambient gas AG1 via the opening OP facing the guide wall surface 107 to amplify the flow rate of the gas PG. An amplified gas (gas stream AG2) is bent toward the projection optical system 30 along a guide wall surface 110 by the coanda effect, and is guided and recovered into the second recovery port 104 along a guide wall surface 108 by the coanda effect again. The opening including the guide wall surface 110 of the nozzle unit 100b forms a second supply port 105 according to the second embodiment, which corresponds to the second supply port 105 according to the first embodiment.

The dimensions of the nozzle unit 100b were set in the following manner to satisfy the above-described amplification and recovery conditions. Referring to FIGS. 5 and 6, a width T1 of the slit 105′ was set at 0.1 mm, all radii R1, R2, and R3 of curvatures of the guide wall surfaces 107, 108, and 110 were set at 3.0 mm. A width T4 of the introduction path of the gas PG was set at 1.0 mm, an interval T2 between the wafer 40 and the nozzle unit 100b was set at 1.0 mm, and a width T3 of the second recovery port 104 was set at 2.0 mm.

A procedure for exposing the wafer 40 is the same as that in the first embodiment.

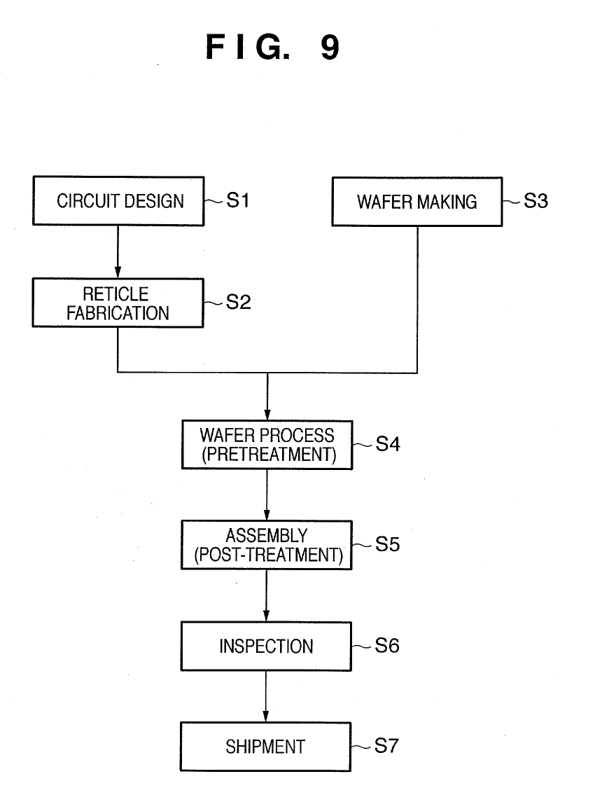

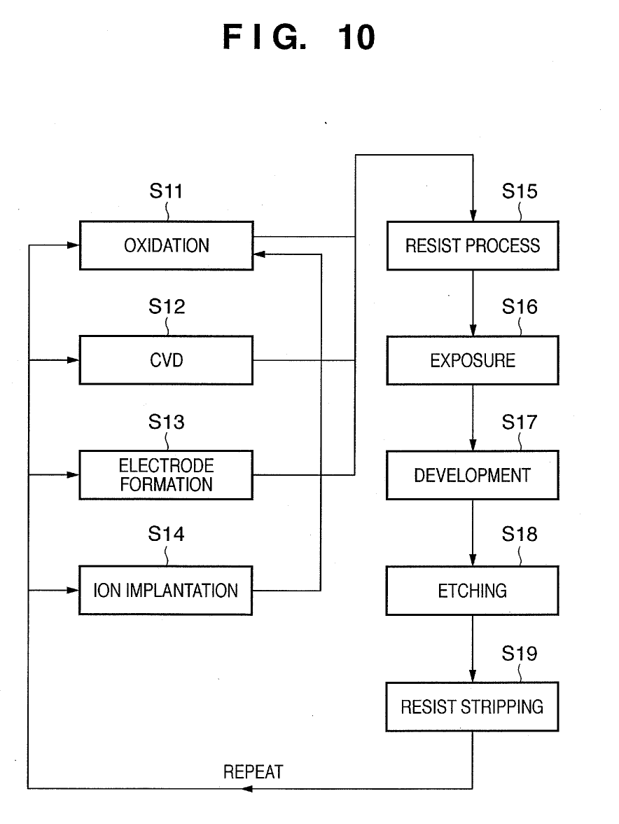

Referring now to FIGS. 9 and 10, a description will be given of an embodiment of a device fabrication method using the above mentioned exposure apparatus 1. FIG. 9 is a flowchart for explaining how to fabricate devices (i.e., semiconductor devices and liquid device). Here, a description will be given of the fabrication of a semiconductor device as an example. Step 1 (circuit design) designs a semiconductor device circuit. Step 2 (reticle fabrication) forms a reticle having a designed circuit pattern. Step 3 (wafer making) manufactures a wafer using materials such as silicon. Step 4 (wafer process), which is also referred to as a pretreatment, forms the actual circuitry on the wafer through lithography using the reticle and wafer. Step 5 (assembly), which is also referred to as a post-treatment, forms into a semiconductor chip the wafer formed in Step 4 and includes an assembly step (e.g., dicing, bonding), a packaging step (chip sealing), and the like. Step 6 (inspection) performs various tests on the semiconductor device made in Step 5, such as a validity test and a durability test. Through these steps, a semiconductor device is finished and shipped (Step 7).

FIG. 10 is a detailed flowchart of the wafer process in Step 4. Step 11 (oxidation) oxidizes the wafer's surface. Step 12 (CVD) forms an insulating layer on the wafer's surface. Step 13 (electrode formation) forms electrodes on the wafer by vapor disposition and the like. Step 14 (ion implantation) implants ions into the wafer. Step 15 (resist process) applies a photosensitive material onto the wafer. Step 16 (exposure) uses the exposure apparatus 1 to expose a circuit pattern from the reticle onto the wafer. Step 17 (development) develops the exposed wafer. Step 18 (etching) etches parts other than a developed resist image. Step 19 (resist stripping) removes unused resist after etching. These steps are repeated to form multi-layer circuit patterns on the wafer. The device fabrication method of this embodiment may manufacture higher quality devices than the conventional one. Thus, the device fabrication method using the exposure apparatus 1, and resultant devices constitute one aspect of the present invention.

Although the embodiments of the present invention have been described above, the present invention is not limited to them and various modifications and changes as will be exemplified in (1) to (5) can be made without departing from the spirit and scope of the present invention.

(1) A third recovery port for recovering the liquid LW may be additionally formed between the liquid recovery port 102 and the second recovery port 104 to enhance the capability to hold the liquid LW.

(2) The gas recovered from the second recovery port 104 may be discharged from, for example, the upper surface of the nozzle unit 100b to the space in the exposure apparatus without connecting the second recovery port 104 to the recovery mechanism (gas supply-recovery mechanism 90) via the gas recovery pipe 94.

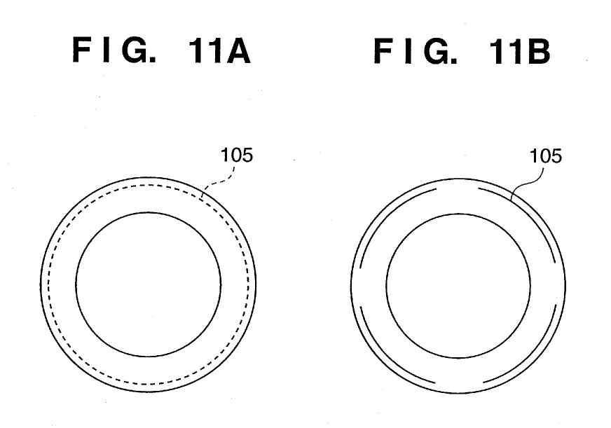

(3) The second supply port 105 need only have a sectional shape shown in any one of FIGS. 2 to 6. The second supply port 105 need not always be continuously arranged around the optical axis OA. For example, as shown in FIGS. 11A and 11B, the second supply port 105 may be divided and arranged around the optical axis OA. FIGS. 11A and 11B are schematic sectional views of the second supply port 105 taken along a plane parallel to the image plane IP.

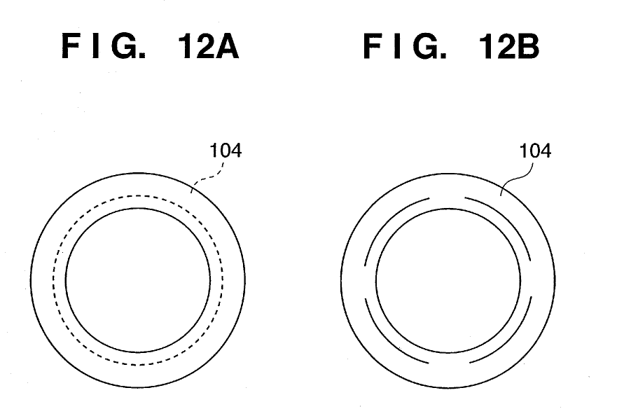

(4) The second recovery port 104 need only have a sectional shape shown in any one of FIGS. 2 to 6. The second recovery port 104 need not always be continuously arranged around the optical axis OA. For example, as shown in FIGS. 12A and 12B, the second recovery port 104 may be divided and arranged around the optical axis OA. FIGS. 12A and 12B are schematic sectional views of the second recovery port 104 taken along a plane parallel to the image plane IP.

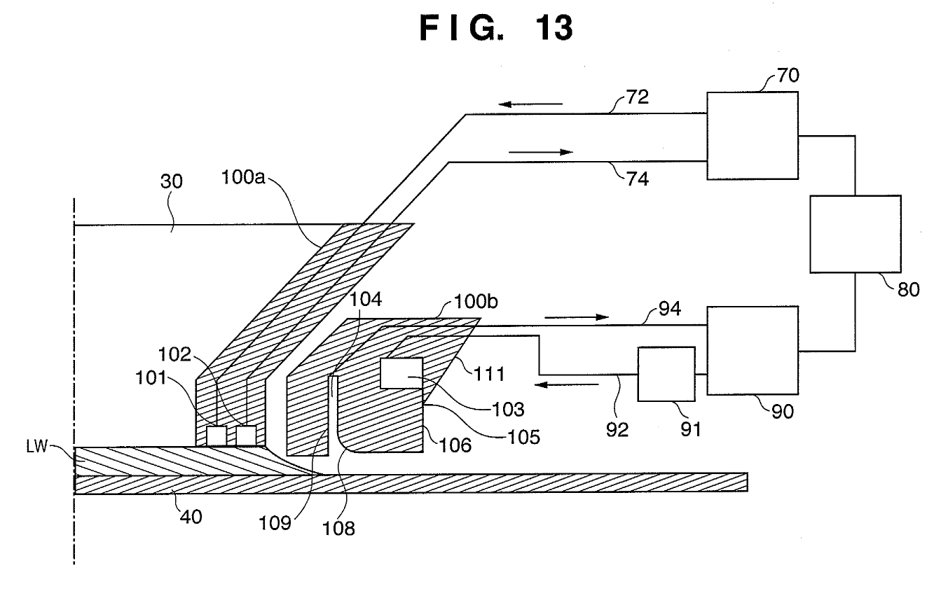

(5) The nozzle unit 100b of the exposure apparatus according to the first embodiment may have a guide wall surface 106 with a longer length instead of using the guide wall surface 107, as shown in FIG. 13. In addition, the guide wall surface 106 need not always be perpendicular to the image plane IP (the surface of the wafer 40), and may be an oblique surface which comes close to the optical axis OA of the final optical element of the projection optical system as it comes close to the image plane IP.

According to the above-described embodiments, it is possible to, for example, obtain a gas stream AG2 at a flow rate sufficient to block a liquid splashing upon moving the wafer 40 at high speed, with a gas supply amount smaller than those in the prior arts. It is also possible to efficiently introduce and recover a gas stream between the wafer 40 and the nozzle unit 100b. This makes it possible to suppress a decrease in throughput upon driving the wafer stage at low speed, and to suppress the generation of defects on the wafer 40 and a decrease in throughput due to the presence of a scattered liquid.

### INDUSTRIAL APPLICABILITY

As has been described above, an exposure apparatus and a device fabrication method according to the present invention are suitable to fabricate devices such as a semiconductor device and liquid crystal device.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-336005 filed on Dec. 13, 2006, which is hereby incorporated by reference herein its entirely.

1. An exposure apparatus which exposes a substrate via a liquid, the apparatus comprising:
a projection optical system configured to project a pattern image of an original onto the substrate;
a liquid supply-recovery mechanism configured to supply the liquid between the projection optical system and the substrate, and to recover the liquid; and
a gas supply-recovery mechanism configured to blow a gas around the liquid supplied between the projection optical system and the substrate,
wherein the gas supply-recovery mechanism includes a nozzle unit in which a supply port configured to supply the gas, and a recovery port which is arranged nearer to an optical axis of the projection optical system than the supply port and is configured to recover the gas are formed, and
wherein the nozzle unit is configured such that a first portion which is nearer to the optical axis than the supply port is closer to an image plane of the projection optical system than a second portion which is adjacent to the supply port and is farther from the optical axis than the supply port, and
the first portion having a part which extends from an inner-side surface of the supply port toward the image plane and is parallel to the optical axis.

2. The apparatus according to claim 1, wherein the first portion includes a surface which faces the image plane and a first round part which faces the image plane and a first round part which extends from the part to the surface, and
the nozzle unit includes a third portion having a second round part which extends from the part to an outer-side surface of the recovery port.

3. The apparatus according to claim 2, wherein the first round part includes an arc.

4. The apparatus according to claim 3, wherein a ratio of a width of the supply port in a direction perpendicular to the optical axis to a radius of the arc is less than 0.35.

5. The apparatus according to claim 4, wherein a length of the part is less than ten times the width.

6. (canceled)

7. (canceled)

8. The apparatus according to claim 2, wherein the second round part includes an arc.

9. The apparatus according to claim 8, wherein a ratio of a minimum distance between the third portion and the image plane of the projection optical system in a direction of the optical axis to a radius of the arc is less than 0.60.

10. (canceled)

11. A device fabrication method comprising steps of:
exposing a substrate using an exposure apparatus according to claim 1; and
performing a development process for the substrate exposed.
